(19) United States
(12) Patent Application Publication
(10) Pub. No.: US 2026/0092005 A1
(43) Pub. Date: Apr. 2, 2026

(54) ALKALI-FREE BORON ALUMINOSILICATE GLASSES WITH HIGH THERMAL STABILITY AND HIGH CRYSTALLIZATION MARGIN AND METHODS FOR PREPARING THE SAME

(71) Applicant: CAIHONG DISPLAY DEVICES CO., LTD., Xianyang (CN)

(72) Inventors: Jing LAN, Xianyang (CN); Lihua XU, Xianyang (CN); Zhao ZENG, Xianyang (CN)

(73) Assignee: CAIHONG DISPLAY DEVICES CO., LTD., Xianyang (CN)

(21) Appl. No.: 19/393,499

(22) Filed: Nov. 18, 2025

Related U.S. Application Data
(63) Continuation of application No. PCT/CN2025/112014, filed on Jul. 31, 2025.

(30) Foreign Application Priority Data
Sep. 29, 2024 (CN) 202411374783.X

(51) Int. Cl. C03C 3/091; C03B 17/06

(52) U.S. Cl. CPC C03C 3/091; C03B 17/064

(57) ABSTRACT

The present disclosure relates to the technical field of electronic glass, and specifically relates to an alkali-free boron aluminosilicate glass with high thermal stability and high crystallization margin and a method for preparing the same. alkali-free boron aluminosilicate glass thermal stability In mole percentage, raw materials for preparing the alkali-free boron aluminosilicate glass with high thermal stability and high crystallization margin include: 68.54 to 72.82% SiO₂, 11.84 to 13.5% Al₂O₃, ≤2.23% B₂O₃, 4.72 to 6.6% MgO, 4.65 to 5.8% CaO, 0.8 to 1.5% SrO, 3.2 to 3.79% BaO, and 0.1% SnO₂, SiO₂+Al₂O₃ is 81.63 to 84.66%, and (MgO+CaO+SrO+BaO)/Al₂O₃ is 1.15 to 1.30.

### CROSS-REFERENCE TO RELATED APPLICATIONS

This application is a Continuation of International Application No. PCT/CN2025/112014, filed on Jul. 31, 2025, which claims priority to Chinese Patent Application No. 202411374783.X, filed on Sep. 29, 2024, the entire contents of each of which are hereby incorporated by reference.

### TECHNICAL FIELD

The present disclosure generally relates to the field of electronic glass technology, and in particular to an alkali-free boron aluminosilicate glass with high thermal stability and high crystallization margin and a method for preparing the same.

### BACKGROUND

With the continuous development of display technologies, the demand for display devices has gradually shifted towards large size, high resolution, and high-definition image quality. Compared with amorphous silicon thin film transistors (TFTs), polysilicon thin film transistors can transmit electrons more rapidly and efficiently and possess higher electron mobility. Therefore, polysilicon enables the fabrication of transistors with smaller sizes and faster switching speeds, thereby producing display devices with higher brightness and quicker response times. However, during the fabrication of polysilicon transistors, a substrate is heated to 450-600° C., which is a significantly higher processing temperature than a peak temperature of approximately 350° C. used for manufacturing amorphous silicon transistors. Under such high temperatures, a substrate glass tends to deform easily. To address this issue, a thermal stability of the substrate glass can be improved by adjusting a glass composition and a forming process. This is mainly because a glass with high thermal stability (i.e., a glass with a high strain point) can prevent deformation caused by poor thermal resistance during a thermal treatment stage of panel manufacturing.

An entire production process of polysilicon substrate glasses needs to be carried out at a higher temperature. A production process temperature of the substrate glass is high, and during melting, the materials in a furnace tend to corrode refractory materials of a production line, resulting in more stone defects in the glass. Meanwhile, a high forming temperature accelerates a creep of overflow bricks, severely affecting the service life of the production line and increasing production costs. In addition, a liquidus temperature of the substrate glass is closely related to the forming process and product quality of the substrate glass. Only when the liquidus temperature of the substrate glass is controlled below a certain threshold, and a difference between the forming temperature and the liquidus temperature (i.e., a crystallization margin) is widened, can the forming process proceed normally. The liquidus temperature of substrate glass is influenced by factors such as a glass composition, a glass structure, and a phase separation. By testing a production process and a liquidus temperature of different batch compositions, an optimal or improved batch composition can be selected. Therefore, accurate measurement of a melting temperature, a forming temperature, and a liquidus temperature of various batch compositions is of practical significance for establishing the production process of a liquid crystal substrate glass, maintaining stability of the forming processes, and controlling the product quality.

The currently available substrate glasses generally possess high crystallization margins and high liquidus viscosities, which significantly reduce the risk of cold-end devitrification in a forming device. However, the thermal stability and devitrification resistance remain insufficient, and it is difficult to achieve both high thermal stability and high devitrification resistance simultaneously.

In view of this, it is necessary to provide a glass with high thermal stability and high crystallization margin to solve the problem that existing glasses cannot achieve both high thermal stability and high devitrification resistance simultaneously.

### SUMMARY

One or more embodiments of the present disclosure provide an alkali-free boron aluminosilicate glass with high thermal stability and high crystallization margin. In mole percentage, raw materials for preparing the alkali-free boron aluminosilicate glass with high thermal stability and high crystallization margin include: 68.54% to 72.82% SiO₂, 11.84% to 13.5% Al₂O₃, ≤2.23% B₂O₃, 4.72% to 6.6% MgO, 4.65% to 5.8% CaO, 0.8% to 1.5% SrO, 3.2% to 3.79% BaO, and 0.1% SnO₂. SiO₂+Al₂O₃ is 81.63% to 84.66%. (MgO+CaO+SrO+BaO)/Al₂O₃ is 1.15 to 1.30.

One or more embodiments of the present disclosure further provide a method for preparing the alkali-free boron aluminosilicate glass with high thermal stability and high crystallization margin, including: mixing the raw materials, melting, and refining to obtain a refined glass melt; and forming the refined glass melt by an overflow downdraw process to obtain the alkali-free boron aluminosilicate glass with high thermal stability and high crystallization margin.

### DETAILED DESCRIPTION

One or more embodiments of the present disclosure provide an alkali-free boron aluminosilicate glass with high thermal stability and high crystallization margin. In mole percentage, raw materials for preparing the alkali-free boron aluminosilicate glass with high thermal stability and high crystallization margin include: 68.54% to 72.82% SiO₂, 11.84% to 13.5% Al₂O₃, ≤2.23% B₂O₃, 4.72% to 6.6% MgO, 4.65% to 5.8% CaO, 0.8% to 1.5% SrO, 3.2% to 3.79% BaO, and 0.1% SnO₂, SiO₂+Al₂O₃ is 81.63% to 84.66%, and (MgO+CaO+SrO+BaO)/Al₂O₃ is 1.15 to 1.30.

In the alkali-free boron aluminosilicate glass with high thermal stability and high crystallization margin, SiO₂ serves as a network former in the glass. SiO₂ forms an irregular continuous network with a structure of silicon-oxygen tetrahedron [SiO₄] to constitute a glass skeleton. SiO₂ is capable of reducing a thermal expansion coefficient of the glass and improving properties of the glass, such as thermal stability, chemical stability, a softening point, a strain point temperature, thermal resistance, hardness, and mechanical strength. If a mole percentage of SiO₂ is lower than 68.54%, it is difficult to increase the strain point, and a density also becomes excessively high. If the mole percentage is higher than 72.82%, in addition to resulting in an increase in high-temperature viscosity and a decrease in meltability, a devitrification crystal is more likely to occur, causing an increase in a liquidus temperature.

In some embodiments of the present disclosure, the mole percentage of SiO₂ is 68.54% to 72.82%. In some embodiments, a source of SiO₂ may be high-purity quartz sand or fused silica powder. The high-purity quartz sand or the fused silica powder is usually in a form of powder or fine particles.

Al₂O₃ serves as a network former oxide. When oxygen atoms in the glass are insufficient, a coordination state of aluminum is an aluminum-oxygen octahedron [AlO₆] located in a network gap. When the oxygen atoms in the glass are in excess, the coordination state of aluminum is an aluminum-oxygen tetrahedron [AlO₄] that enters a glass structure to play a network-forming role. Al₂O₃ is capable of increasing the stability of the glass, reducing the thermal expansion coefficient, and increasing the hardness of the glass. Increasing a mole percentage of Al₂O₃ can increase a strain point temperature and elastic modulus of the glass. However, if the mole percentage is higher than 13.5%, the devitrification crystal, such as a mullite and an anorthite, is likely to precipitate, causing an increase in the liquidus temperature.

In some embodiments of the present disclosure, the mole percentage of Al₂O₃ is 11.84% to 13.5%. In some embodiments, a source of Al₂O₃ may be α-alumina powder or industrial alumina. The α-alumina powder or industrial alumina is usually in a form of a fine powder.

B₂O₃ mainly functions to reduce the viscosity of the glass at high temperatures to play a fluxing role, and to increase the viscosity of the glass at low temperatures to reduce the liquidus temperature. However, an excessive content of B₂O₃ causes an increase in the thermal expansion coefficient of the glass, a decrease in the strain point temperature, and a decrease in the elastic modulus. If a mole percentage of B₂O₃ is higher than 2.23%, the strain point temperature of the glass decreases significantly, resulting in large thermal deformation during display processing.

In some embodiments of the present disclosure, the mole percentage of B₂O₃ is ≤2.23%. In some embodiments, a source of B₂O₃ may be boric acid or borax. The boric acid or borax is usually in a form of powder or crystalline granular solid.

MgO is used to reduce the high-temperature viscosity and improve the melting performance of the glass. If a content of MgO is excessively high, the strain point temperature decreases significantly, and the liquidus temperature increases, resulting in poor devitrification resistance, which is unfavorable for an overflow downdraw forming process.

In some embodiments of the present disclosure, the mole percentage of MgO is 4.72% to 6.6%. In some embodiments, a source of MgO may be light-burned magnesia powder or basic magnesium carbonate. The light-burned magnesia powder or basic magnesium carbonate is usually in a form of powder.

CaO is a component that reduces the high-temperature viscosity and significantly improves the meltability without decreasing the strain point temperature. However, if a content of CaO is excessively high, the glass is prone to devitrification, and the thermal expansion coefficient becomes excessively high.

In some embodiments of the present disclosure, a mole percentage of CaO is 4.65% to 5.8%. In some embodiments, a source of CaO may be calcium carbonate or quicklime. The calcium carbonate or quicklime is usually in a form of powder or fine granular solid.

Similar to CaO, SrO is the component that reduces the high-temperature viscosity and significantly improves the meltability without decreasing the strain point temperature. Meanwhile, SrO is also a component that inhibits phase separation and improves devitrification resistance, and therefore serves as a component that inhibits an increase in the liquidus temperature. If a content of SrO is excessively low, it is difficult to achieve an effect of inhibiting the phase separation to improve the devitrification resistance. However, if the content is excessively high, devitrification crystallization of a strontium silicate series is likely to occur, causing a decrease in the devitrification resistance.

In some embodiments of the present disclosure, a mole percentage of SrO is 0.8% to 1.5%. In some embodiments, a source of SrO may be strontium carbonate or strontium oxide. The strontium carbonate or strontium oxide is usually in a form of a powder.

Compared with SrO, BaO is a component that significantly improves the devitrification resistance. BaO is beneficial for reducing the liquidus temperature of the glass. However, if BaO replaces other alkaline earth metal oxides or a content of BaO is excessively high, a melting temperature will increase, the high-temperature viscosity will increase, and the melting performance will decrease. Meanwhile, as a divalent network modifier oxide, BaO causes severe erosion to refractory materials. Based on development trends of environmental protection and lightweight of substrate glass, an addition amount of BaO must be controlled.

In some embodiments of the present disclosure, a mole percentage of BaO is 3.2% to 3.79%. In some embodiments, a source of BaO may be barium carbonate or barium oxide. The barium carbonate or barium oxide is usually in a form of a powder.

SnO₂ is added to a basic glass composition as a refining agent, which promotes elimination or dissolution and absorption of bubbles in a glass melt. A mole percentage of SnO₂ is designed to be 0.1%, which facilitates the elimination or dissolution and absorption of bubbles in the glass melt. In some embodiments, a source of SnO₂ may be tin oxide or stannous chloride. Tin oxide or stannous chloride is usually in a form of powder solid.

Both SiO₂ and Al₂O₃ are the network former oxides, and each contributes to increasing the strain point. However, when a content of SiO₂ increases, devitrification crystals such as cristobalite tend to precipitate. When a content of Al₂O₃ is excessive, devitrification crystals of an alkaline earth aluminosilicate series, such as mullite and anorthite, tend to precipitate.

In some embodiments of the present disclosure, a mole percentage of SiO₂+Al₂O₃ is 81.63% to 84.66%.

RO represents alkaline earth metal oxides, including MgO, CaO, SrO, BaO, etc. A ratio of a total mole amount of the alkaline earth metal oxides (MgO+CaO+SrO+BaO) to a mole amount of Al₂O₃ (also referred to as (MgO+CaO+SrO+BaO)/Al₂O₃) is designed to form new compounds with silicates in the glass, thereby reducing a melting point of the glass and improving the chemical stability of the glass. The ratio also takes into account requirements for a high specific modulus and the high strain point, thereby improving the devitrification resistance. If the ratio is too small, the devitrification crystals induced by alkaline earth components tend to precipitate; if the ratio is too large, the devitrification crystals of the alkaline earth aluminosilicate series such as anorthite tend to precipitate.

In some embodiments of the present disclosure, (MgO+CaO+SrO+BaO)/Al₂O₃ is 1.15 to 1.30, which makes the glass have high thermal stability, high crystallization margin (difference between a forming temperature and the liquidus temperature), and high liquidus viscosity, which is beneficial to stability of the overflow downdraw forming process.

In some embodiments, in mole percentage, the raw materials of the alkali-free boron aluminosilicate glass with high thermal stability and high crystallization margin may further include: 69.12% to 72.82% SiO₂, 11.84% to 13.1% Al₂O₃, ≤2.23% B₂O₃, 5.28% to 6.59% MgO, 4.65% to 5.78% CaO, 0.8% to 1.5% SrO, 3.2% to 3.79% BaO, and 0.1% SnO₂, SiO₂+Al₂O₃ is 81.63% to 84.66%, and (MgO+CaO+SrO+BaO)/Al₂O₃ is 1.15 to 1.30.

In some embodiments, in mole percentage, the raw materials of the alkali-free boron aluminosilicate glass with high thermal stability and high crystallization margin may further include: 69.33% to 72.82% SiO₂, 11.84% to 13.1% Al₂O₃, ≤2.23% B₂O₃, 5.28% to 6.59% MgO, 4.65% to 5.52% CaO, 0.8% to 1.5% SrO, 3.2% to 3.79% BaO, and 0.1% SnO₂, SiO₂+Al₂O₃ is 81.63% to 84.66%, and (MgO+CaO+SrO+BaO)/Al₂O₃ is 1.15 to 1.30.

In some embodiments, in mole percentage, the raw materials of the alkali-free boron aluminosilicate glass with high thermal stability and high crystallization margin may further include: 70.5% to 72.82% SiO₂, 11.84% to 13.1% Al₂O₃, ≤1.23% B₂O₃, 5.28% to 6.29% MgO, 4.99% to 5.01% CaO, 0.8% to 1.1% SrO, 3.54% to 3.79% BaO, and 0.1% SnO₂, SiO₂+Al₂O₃ is 83% to 84.66%, and (MgO+CaO+SrO+BaO)/Al₂O₃ is 1.15 to 1.29.

In some embodiments, in mole percentage, the raw materials of the alkali-free boron aluminosilicate glass with high thermal stability and high crystallization margin may further include: 72.82% SiO₂, 11.84% Al₂O₃, 5.28% MgO, 5.32% CaO, 1.1% SrO, 3.54% BaO, and 0.1% SnO₂, SiO₂+Al₂O₃ is 84.66%, and (MgO+CaO+SrO+BaO)/Al₂O₃ is 1.29.

In some embodiments of the present disclosure, for the provided alkali-free boron aluminosilicate glass with high thermal stability and high crystallization margin (also referred to as the alkali-free boron aluminosilicate glass), by controlling the compositions and the mole percentages, the strain point temperature of the alkali-free boron aluminosilicate glass is increased and a deformation amount of the alkali-free boron aluminosilicate glass is reduced during panel processing and manufacturing. Meanwhile, crystallization margin of the alkali-free boron aluminosilicate glass in the overflow downdraw forming process is improved, a crystallization defect rate is reduced, a service life of a production line is prolonged, and a production cost of the glass is lowered.

In some embodiments, a strain point temperature of the alkali-free boron aluminosilicate glass with high thermal stability and high crystallization margin is higher than 735° C.

In some embodiments, the strain point temperature of the alkali-free boron aluminosilicate glass with high thermal stability and high crystallization margin is higher than 735.2° C.

In some embodiments, the strain point temperature of the alkali-free boron aluminosilicate glass with high thermal stability and high crystallization margin is in a range of 736 to 754.1° C.

In some embodiments, the strain point temperature of the alkali-free boron aluminosilicate glass with high thermal stability and high crystallization margin is in a range of 743.2 to 754.1° C.

In some embodiments, the strain point temperature of the alkali-free boron aluminosilicate glass with high thermal stability and high crystallization margin is 754.1° C.

In some embodiments of the present disclosure, by controlling the strain point temperature of the alkali-free boron aluminosilicate glass with high thermal stability and high crystallization margin to be higher than 735° C., a glass with the high strain point can be obtained. In the manufacturing of polysilicon transistor displays, the glass with the high strain point can inhibit thermal deformation of a glass plate, thereby improving the yield rate of display production.

In some embodiments, a liquidus viscosity of the alkali-free boron aluminosilicate glass with high thermal stability and high crystallization margin is higher than 203426 P, and a crystallization margin is higher than 80° C.

In some embodiments, the liquidus viscosity of the alkali-free boron aluminosilicate glass with high thermal stability and high crystallization margin is higher than 200000 P, and the crystallization margin is higher than 80° C.

In some embodiments, the liquidus viscosity of the alkali-free boron aluminosilicate glass with high thermal stability and high crystallization margin is higher than 203426.2 P, and the crystallization margin is higher than 80.2° C.

In some embodiments, the liquidus viscosity of the alkali-free boron aluminosilicate glass with high thermal stability and high crystallization margin is in a range of 211706.6 to 357812 P, and the crystallization margin is in a range of 81.1 to 107.1° C.

In some embodiments, the liquidus viscosity of the alkali-free boron aluminosilicate glass with high thermal stability and high crystallization margin is in a range of 226700 to 357812 P, and the crystallization margin is in a range of 87.1 to 107.1° C.

In some embodiments, the liquidus viscosity of the alkali-free boron aluminosilicate glass with high thermal stability and high crystallization margin is in a range of 226700 to 357812 P, and the crystallization margin is in a range of 92.8 to 107.1° C.

In some embodiments, the liquidus viscosity of the alkali-free boron aluminosilicate glass with high thermal stability and high crystallization margin is 357812 P, and the crystallization margin is 107.1° C.

In some embodiments of the present disclosure, by controlling the liquidus viscosity of the alkali-free boron aluminosilicate glass with high thermal stability and high crystallization margin to be higher than 200000 P, excellent forming performance of the glass melt can be achieved, and it is easy to form the glass plate by the overflow downdraw process, which can improve surface quality of the glass plate and reduce a manufacturing cost of the glass plate.

Some embodiments of the present disclosure further provide a method for preparing the alkali-free boron aluminosilicate glass with high thermal stability and high crystallization margin, including: mixing the raw materials, melting, and refining to obtain a refined glass melt; and forming the refined glass melt by the overflow downdraw process to obtain the alkali-free boron aluminosilicate glass with high thermal stability and high crystallization margin.

In some embodiments, a temperature of the melting is in a range of 1590° C. to 1630° C. In some embodiments, the temperature of the melting may be in a range of 1590 to 1620° C., 1590 to 1610° C., 1590 to 1600° C., 1600 to 1620° C., 1610 to 1620° C., etc. In some embodiments, the temperature of the melting may be 1590° C., 1600° C., 1610° C., 1620° C., or 1630° C.

In some embodiments of the present disclosure, by controlling the temperature of the melting to be in the range of 1590 to 1630° C., sufficient melting of the raw materials can be ensured, thereby avoiding defects such as stones in the glass caused by incomplete melting. At the same time, melting properties of a raw material system can be well matched, achieving a balance between the high-temperature viscosity and melting efficiency.

In some embodiments, a temperature of the forming is in a range of 1270 to 1300° C. In some embodiments, the temperature of the forming may be in a range of 1270 to 1290° C., 1270 to 1280° C., 1280 to 1290° C., 1280 to 1300° C., 1290 to 1300° C., etc. In some embodiments, the temperature of the forming may be in a range of 1250 to 1310° C. In some embodiments, the temperature of the forming may be 1270° C., 1280° C., 1290° C., or 1300° C.

In some embodiments of the present disclosure, by controlling the temperature of the forming to be in the range of 1270 to 1300° C. and adapting the temperature to the overflow downdraw process, the difference between the forming temperature and the liquidus temperature (i.e., the crystallization margin) is increased, ensuring stability during the forming process and reducing a risk of cold-end devitrification. In addition, the high liquidus viscosity of the glass is maintained, further improving the surface quality of the glass plate, while also meeting operational requirements of production line devices, thereby extending the service life of key components such as overflow bricks and reducing the production costs of the glass.

In some embodiments, the method for preparing the alkali-free boron aluminosilicate glass with high thermal stability and high crystallization margin includes the following steps:

(1) calculating and weighing the raw material corresponding to each component according to the mole percentage, adding the raw material of the each component into a mixer, and mixing uniformly to obtain a mixed material.

(2) feeding the mixed material into a glass furnace, heating and melting the mixed material in the glass furnace to form the glass melt, and then allowing the glass melt to flow into a platinum channel for refining to obtain the refined glass melt;

(3) forming the refined glass melt by the overflow downdraw forming process to obtain a sheet glass, which is the alkali-free boron aluminosilicate glass with high thermal stability and high crystallization margin.

In some embodiments, in step (2), the temperature of the melting is in the range of 1590 to 1630° C.

In some embodiments, in step (3), the temperature of the forming is in the range of 1270 to 1300° C., and the temperature of the forming is a temperature in the overflow downdraw forming process during glass preparation.

In some embodiments of the present disclosure, the method for preparing the alkali-free boron aluminosilicate glass with high thermal stability and high crystallization margin ensures the excellent forming performance of the glass melt and is conducive to improving the surface quality of the glass plate. In some embodiments, by controlling components and mole percentages of the raw materials in the method, a glass with both the high thermal stability and the high devitrification resistance is obtained, thereby reducing the deformation amount of the glass during the panel processing. In some embodiments, by combining the overflow downdraw process with composition optimization, the crystallization margin of the glass is increased, the crystallization defect rate is reduced, the service life of the production line is extended, and the manufacturing cost is lowered.

An implementation process of the present disclosure is described in detail below with reference to specific embodiments.

In the following embodiments, all raw materials used are commercially available products or can be prepared according to conventional techniques in the art.

To further illustrate the method for preparing an alkali-free boron aluminosilicate glass with high thermal stability and high crystallization margin provided by the present disclosure, Examples 1-20 are provided as follows.

The Examples 1-20 each provide the alkali-free boron aluminosilicate glass with high thermal stability and high crystallization margin. The method for preparing the alkali-free boron aluminosilicate glass with high thermal stability and high crystallization margin included following steps:
(1) According to component ratios in Table 1 and Table 2, the raw material corresponding to each component was calculated and weighed, and then all raw materials were poured into a mixer and uniformly mixed to obtain a mixed material;
(2) The mixed material was fed into a glass furnace, where the mixed material was heated and melted to form a glass melt. The glass melt was then allowed to flow into a platinum channel for refining to obtain a refined glass melt; a temperature of the melting was 1600° C.;
(3) The refined glass melt was formed into a glass sheet by an overflow downdraw forming process to obtain the alkali-free boron aluminosilicate glass with high thermal stability and high crystallization margin; a temperature of the forming was 1280° C.

In some embodiments of the present disclosure, when the temperature of the melting is 1590° C. or 1630° C., the prepared alkali-free boron aluminosilicate glass with high thermal stability and high crystallization margin achieves the same technical effects as the above embodiments.

In some embodiments of the present disclosure, when the temperature of the forming is 1270° C. or 1300° C., the prepared alkali-free boron aluminosilicate glass with high thermal stability and high crystallization margin achieves the same technical effects as the above embodiments.

TABLE 1
Component ratios of the alkali-free boron aluminosilicate glass in Examples 1-10

| Components | Examples | | | | | | | | | |
|---|---|---|---|---|---|---|---|---|---|---|
| (mol %) | 1 | 2 | 3 | 4 | 5 | 6 | 7 | 8 | 9 | 10 |
| SiO₂ | 69.33 | 71.23 | 70.22 | 69.12 | 68.54 | 72.82 | 70.55 | 69.5 | 69.68 | 69.64 |
| Al₂O₃ | 12.3 | 12.2 | 12.1 | 12.8 | 13.5 | 11.84 | 13.1 | 12.5 | 12.7 | 13.2 |
| B₂O₃ | 2.23 | 1.9 | 2.03 | 1.68 | 1.83 | 0 | 1.23 | 2.1 | 1.8 | 1.93 |
| MgO | 5.82 | 4.72 | 6.6 | 6.03 | 6.35 | 5.28 | 5.42 | 6.09 | 5.32 | 5.74 |
| CaO | 5.52 | 5.8 | 4.65 | 5.78 | 5.28 | 5.32 | 5.01 | 5.12 | 5.8 | 5.15 |
| SrO | 1.5 | 0.8 | 1.05 | 1.2 | 1.11 | 1.1 | 0.8 | 0.8 | 1.1 | 1 |
| BaO | 3.2 | 3.25 | 3.25 | 3.29 | 3.29 | 3.54 | 3.79 | 3.79 | 3.5 | 3.24 |
| SnO₂ | 0.1 | 0.1 | 0.1 | 0.1 | 0.1 | 0.1 | 0.1 | 0.1 | 0.1 | 0.1 |
| Total | 100 | 100 | 100 | 100 | 100 | 100 | 100 | 100 | 100 | 100 |
| SiO₂ + Al₂O₃ | 81.63 | 83.43 | 82.32 | 81.92 | 82.04 | 84.66 | 83.65 | 82 | 82.38 | 82.84 |
| RO/Al₂O₃ | 1.3 | 1.19 | 1.29 | 1.27 | 1.19 | 1.29 | 1.15 | 1.26 | 1.24 | 1.15 |

TABLE 2
Component ratios of the alkali-free boron aluminosilicate glass in Examples 11-20

| Components | Examples | | | | | | | | | |
|---|---|---|---|---|---|---|---|---|---|---|
| (mol %) | 11 | 12 | 13 | 14 | 15 | 16 | 17 | 18 | 19 | 20 |
| SiO₂ | 69.09 | 69.54 | 68.63 | 68.84 | 70.2 | 69.81 | 69.51 | 70.1 | 69.9 | 70.5 |
| Al₂O₃ | 13.3 | 12.8 | 13.4 | 13.5 | 12.9 | 12.9 | 13.3 | 12.8 | 12.9 | 12.5 |
| B₂O₃ | 2.13 | 1.83 | 2.13 | 2.05 | 0.53 | 1.8 | 1.5 | 1.23 | 1.23 | 1.03 |
| MgO | 5.77 | 6.59 | 5.9 | 5.97 | 5.89 | 5.75 | 5.85 | 5.79 | 5.59 | 6.29 |
| CaO | 5.02 | 4.65 | 5.35 | 5.15 | 5.49 | 5.15 | 5.15 | 5.39 | 5.69 | 4.99 |
| SrO | 1.1 | 1.2 | 1.1 | 1.1 | 1.1 | 1.2 | 1.2 | 0.8 | 0.8 | 0.8 |
| BaO | 3.49 | 3.29 | 3.39 | 3.29 | 3.79 | 3.29 | 3.39 | 3.79 | 3.79 | 3.79 |
| SnO₂ | 0.1 | 0.1 | 0.1 | 0.1 | 0.1 | 0.1 | 0.1 | 0.1 | 0.1 | 0.1 |
| Total | 100 | 100 | 100 | 100 | 100 | 100 | 100 | 100 | 100 | 100 |
| SiO₂ + Al₂O₃ | 82.39 | 82.34 | 82.03 | 82.34 | 83.1 | 82.71 | 82.81 | 82.9 | 82.8 | 83 |
| RO/Al₂O₃ | 1.3 | 1.19 | 1.29 | 1.27 | 1.19 | 1.29 | 1.15 | 1.26 | 1.24 | 1.15 |

A strain point temperature, a forming temperature, a liquidus temperature, a liquidus viscosity, and a crystallization margin of the alkali-free boron aluminosilicate glass with high thermal stability and high crystallization margin prepared in Examples 1-20 were tested and calculated. The strain point temperature was measured according to a standard test method of ASTM C336, by drawing the glass into a glass fiber as required by the ASTM C336 and detecting the strain point temperature using a specialized device. For testing and calculation of the liquidus viscosity, a viscosity-temperature curve test of the glass was first performed. The viscosity-temperature curve test was performed according to a standard test method of ASTM C-965. The sheet glass prepared in Examples 1-20 was crushed and sieved through a sieve to obtain glass particles of 10 to 30 mesh. The obtained glass particles were placed in corresponding containers and heated until the glass particles are melted into the glass melt. A rotor was then immersed into the glass melt and rotated at different speeds. Torque values corresponding to various rotational speeds were recorded using a dedicated software, and viscosities of the glass melt at different temperatures were calculated accordingly. Finally, based on the viscosity-temperature curve obtained from the viscosity test, corresponding liquidus viscosity was calculated. The forming temperature is a temperature corresponding to respective viscosity on the obtained viscosity-temperature curve. The liquidus temperature was tested and calculated by crushing the sheet glass prepared in Examples 1-20, sieving the crushed sheet glass through the sieve to obtain glass particles of 10 to 30 mesh, placing the obtained glass particles in an elongated container, placing the container in a furnace with a temperature gradient, maintaining the container at a certain temperature for 24 hours, then removing the container, observing positions corresponding to initial crystallization after cooling under a microscope, and calculating corresponding temperature values to obtain the liquidus temperature. The crystallization margin is difference between the forming temperature and the liquidus temperature. Specific test results are shown in Table 3 and Table 4:

TABLE 3
Performance test results of the alkali-free boron aluminosilicate glass prepared in Examples 1-10

| Performance | Examples | | | | | | | | | |
|---|---|---|---|---|---|---|---|---|---|---|
| parameters | 1 | 2 | 3 | 4 | 5 | 6 | 7 | 8 | 9 | 10 |
| Strain point | 736.5 | 735.2 | 735.6 | 739.5 | 739.6 | 754.1 | 750.8 | 736 | 735.3 | 743.3 |
| temperature/ | | | | | | | | | | |
| ° C. | | | | | | | | | | |
| Forming | 1289.3 | 1281.7 | 1280.7 | 1282.6 | 1272.9 | 1311.6 | 1290.4 | 1285.5 | 1285.9 | 1287.3 |
| temperature/ | | | | | | | | | | |
| ° C. | | | | | | | | | | |
| Liquidus | 1202.2 | 1201.6 | 1198.3 | 1201.5 | 1191.7 | 1204.5 | 1197.6 | 1190.9 | 1205.7 | 1202.3 |
| temperature/ | | | | | | | | | | |
| ° C. | | | | | | | | | | |
| Liquidus | 245312 | 232426 | 222184 | 213645 | 208039 | 357812 | 226700 | 249737 | 205643.4 | 209083.5 |
| viscosity/P | | | | | | | | | | |
| Crystallization | 87.1 | 80.1 | 82.4 | 81.1 | 81.2 | 107.1 | 92.8 | 94.6 | 80.2 | 85 |
| margin/ | | | | | | | | | | |
| ° C. | | | | | | | | | | |

TABLE 4
Performance test results of the alkali-free boron aluminosilicate glass prepared in Examples 11-20

| Performance | Examples | | | | | | | | | |
|---|---|---|---|---|---|---|---|---|---|---|
| parameters | 1 | 2 | 3 | 4 | 5 | 6 | 7 | 8 | 9 | 10 |
| Strain | 738.6 | 736 | 737.9 | 737.9 | 749.9 | 742.8 | 745.2 | 746.7 | 738.1 | 743.2 |
| point | | | | | | | | | | |
| temperature/ | | | | | | | | | | |
| ° C. | | | | | | | | | | |
| Forming | 1275.5 | 1282.3 | 1275.8 | 1276.9 | 1299.4 | 1280.3 | 1284.9 | 1292.8 | 1290.1 | 1288.4 |
| temperature/ | | | | | | | | | | |
| ° C. | | | | | | | | | | |
| Liquidus | 1192 | 1180.6 | 1195.6 | 1196.1 | 1213.6 | 1198.7 | 1204.5 | 1206.1 | 1205.4 | 1188 |
| temperature/ | | | | | | | | | | |
| ° C. | | | | | | | | | | |
| Liquidus | 203426.2 | 308212.7 | 229856.4 | 216979.5 | 211706.6 | 208092 | 216572.8 | 207382.4 | 209876.2 | 274502.3 |
| viscosity/P | | | | | | | | | | |
| Crystallization | 80.5 | 101.7 | 80.2 | 80.8 | 85.8 | 81.6 | 80.4 | 86.7 | 84.7 | 100.4 |
| margin/ | | | | | | | | | | |
| ° C. | | | | | | | | | | |

As shown in Table 3 and Table 4, in some embodiments of the present disclosure, the strain point temperature of the alkali-free boron aluminosilicate glass with high thermal stability and high crystallization margin is higher than 735.2° C., with a maximum of 754.1° C., the liquidus viscosity is higher than 203,426.2 P, with a maximum of 357,812 P, and the crystallization margin is higher than 80.2° C., with a maximum of 107.1° C. In Example 6, the alkali-free boron aluminosilicate glass with high thermal stability and high crystallization margin exhibits the highest strain point temperature, the highest liquidus viscosity, and the highest crystallization margin. This indicates that for the alkali-free boron aluminosilicate glass with high thermal stability and high crystallization margin provided in some embodiments of the present disclosure, by controlling mole percentage ranges of the raw materials, the alkali-free boron aluminosilicate glass possesses a high strain point, reducing a deformation amount of the alkali-free boron aluminosilicate glass during panel processing and manufacturing, and improving thermal resistance. At the same time, the crystallization margin and the liquidus viscosity of the alkali-free boron aluminosilicate glass in the overflow downdraw forming process are increased, a crystallization defect rate is reduced, devitrification resistance of the alkali-free boron aluminosilicate glass is improved, the service life of the production line is extended, and production costs of the glass is reduced. The alkali-free boron aluminosilicate glass with high thermal stability and high crystallization margin of the present disclosure simultaneously achieves both high thermal stability and high devitrification resistance.

The embodiments of the present disclosure have the following beneficial effects. SiO₂ is the network former in the glass. By designing the mole percentage of SiO₂ to be 68.54% to 72.82%, the thermal expansion coefficient of the alkali-free boron aluminosilicate glass is reduced and performance, such as the thermal stability, the chemical stability, the softening point, the strain point, the thermal resistance, the hardness, and the mechanical strength of the alkali-free boron aluminosilicate glass are improved. By designing the mole percentage of Al₂O₃ to be 11.84% to 13.5%, the stability of the alkali-free boron aluminosilicate glass is increased, the thermal expansion coefficient is reduced, and the hardness of the glass is increased. By designing the mole percentage of B₂O₃ to be ≤2.23%, the viscosity of the alkali-free boron aluminosilicate glass is increased, and the liquidus temperature is reduced. By designing the mole percentage of MgO to be 4.72% to 6.6%, high-temperature viscosity of the alkali-free boron aluminosilicate glass is reduced, and the melting performance of the alkali-free boron aluminosilicate glass is improved. At the same time, by designing the mole percentage of CaO to be 4.65% to 5.8%, the high-temperature viscosity of the alkali-free boron aluminosilicate glass is also reduced, and the meltability of the alkali-free boron aluminosilicate glass is significantly improved. By designing the mole percentage of SrO to be 0.8% to 1.5%, a rise in the liquidus temperature of the alkali-free boron aluminosilicate glass is suppressed. By designing the mole percentage of BaO to be 3.2% to 3.79%, the liquidus temperature of the alkali-free boron aluminosilicate glass is reduced. By designing the mole percentage of SnO₂ as the refining agent to be 0.1%, the bubbles in the glass melt of the alkali-free boron aluminosilicate glass are eliminated or dissolved. In addition, by designing the mole percentage of SiO₂+Al₂O₃ to be 81.63% to 84.66%, the strain point temperature of the alkali-free boron aluminosilicate glass is increased. By designing (MgO+CaO+SrO+BaO)/Al₂O₃ to be 1.15 to 1.30, the alkali-free boron aluminosilicate glass achieves both the high specific modulus and the high strain point, thereby improving the devitrification resistance.

The alkali-free boron aluminosilicate glass with high thermal stability and high crystallization margin provided in the present disclosure increases the strain point temperature of the alkali-free boron aluminosilicate glass and reduces the deformation amount of the alkali-free boron aluminosilicate glass during the panel processing by controlling the compositions and the mole percentages. At the same time, the crystallization margin of the alkali-free boron aluminosilicate glass in the overflow downdraw forming process is increased, the crystallization defect rate is reduced, the service life of the production line is extended, and the production cost of the glass is reduced. The alkali-free boron aluminosilicate glass with high thermal stability and high crystallization margin achieves both high thermal stability and devitrification resistance.

The foregoing descriptions are merely preferred implementations of the present disclosure, and are not intended to limit the present disclosure. For those skilled in the art, the present disclosure may have various modifications and changes. Any modifications, equivalent replacements, improvements, etc., made within the spirit and principle of the present disclosure shall be included within the protection scope of the present disclosure.

What is claimed is:

1. An alkali-free boron aluminosilicate glass with high thermal stability and high crystallization margin, wherein, in mole percentage, raw materials for preparing the alkali-free boron aluminosilicate glass with high thermal stability and high crystallization margin include: 68.54% to 72.82% SiO₂, 11.84% to 13.5% Al₂O₃, ≤2.23% B₂O₃, 4.72% to 6.6% MgO, 4.65% to 5.8% CaO, 0.8% to 1.5% SrO, 3.2% to 3.79% BaO, and 0.1% SnO₂, SiO₂+Al₂O₃ is 81.63% to 84.66%, and (MgO+CaO+SrO+BaO)/Al₂O₃ is 1.15 to 1.30.

2. The alkali-free boron aluminosilicate glass with high thermal stability and high crystallization margin according to claim 1, wherein, in mole percentage, the raw materials include: 69.12% to 72.82% SiO₂, 11.84% to 13.1% Al₂O₃, ≤2.23% B₂O₃, 5.28% to 6.59% MgO, 4.65% to 5.78% CaO, 0.8% to 1.5% SrO, 3.2% to 3.79% BaO, and 0.1% SnO₂, SiO₂+Al₂O₃ is 81.63% to 84.66%, and (MgO+CaO+SrO+BaO)/Al₂O₃ is 1.15 to 1.30.

3. The alkali-free boron aluminosilicate glass with high thermal stability and high crystallization margin according to claim 1, wherein, in mole percentage, the raw materials include: 69.33% to 72.82% SiO₂, 11.84% to 13.1% Al₂O₃, ≤2.23% B₂O₃, 5.28% to 6.59% MgO, 4.65% to 5.52% CaO, 0.8% to 1.5% SrO, 3.2% to 3.79% BaO, and 0.1% SnO₂, SiO₂+Al₂O₃ is 81.63% to 84.66%, and (MgO+CaO+SrO+BaO)/Al₂O₃ is 1.15 to 1.30.

4. The alkali-free boron aluminosilicate glass with high thermal stability and high crystallization margin according to claim 1, wherein, in mole percentage, the raw materials include: 70.5% to 72.82% SiO₂, 11.84% to 13.1% Al₂O₃, ≤1.23% B₂O₃, 5.28% to 6.29% MgO, 4.99% to 5.01% CaO, 0.8% to 1.1% SrO, 3.54% to 3.79% BaO, and 0.1% SnO₂, SiO₂+Al₂O₃ is 83% to 84.66%, and (MgO+CaO+SrO+BaO)/Al₂O₃ is 1.15 to 1.29.

5. The alkali-free boron aluminosilicate glass with high thermal stability and high crystallization margin according to claim 1, wherein, in mole percentage, the raw materials include: 72.82% SiO₂, 11.84% Al₂O₃, 5.28% MgO, 5.32% CaO, 1.1% SrO, 3.54% BaO, and 0.1% SnO₂, SiO₂+Al₂O₃ is 84.66%, and (MgO+CaO+SrO+BaO)/Al₂O₃ is 1.29.

6. The alkali-free boron aluminosilicate glass with high thermal stability and high crystallization margin according to claim 1, wherein a strain point temperature of the alkali-free boron aluminosilicate glass with high thermal stability and high crystallization margin is higher than 735° C.

7. The alkali-free boron aluminosilicate glass with high thermal stability and high crystallization margin according to claim 1, wherein a liquidus viscosity of the alkali-free boron aluminosilicate glass with high thermal stability and high crystallization margin is higher than 203426 P, and a crystallization margin of the alkali-free boron aluminosilicate glass with high thermal stability and high crystallization margin is higher than 80° C.

8. A method for preparing the alkali-free boron aluminosilicate glass with high thermal stability and high crystallization margin according to claim 1, comprising: mixing the raw materials, melting, and refining to obtain a refined glass melt; and forming the refined glass melt by an overflow downdraw process to obtain the alkali-free boron aluminosilicate glass with high thermal stability and high crystallization margin.

9. The method according to claim 8, wherein a temperature of the melting is in a range of 1590° C. to 1630° C.

10. The method according to claim 8, wherein a temperature of the forming is in a range of 1270° C. to 1300° C.
